(19) United States
(12) Patent Application Publication
(10) Pub. No.: US 2011/0088886 A1
(43) Pub. Date: Apr. 21, 2011

(54) HEAT EXCHANGER AND SEAL ARRANGEMENT FOR THE SAME

(76) Inventors: Klaus Kalbacher, Rangendingen (DE); Steffen Schmidt, Schomberg (DE); Juergen Zeitlinger, Reutlingen (DE); Thomas Braeuning, Stuttgart (DE)

(21) Appl. No.: 12/905,117

(22) Filed: Oct. 15, 2010

(30) Foreign Application Priority Data
Oct. 15, 2009 (DE) 10 2009 049 483.9

(51) Int. Cl. F28F 9/06; F16L 19/00

(52) U.S. Cl. 165/178; 277/608

(57) ABSTRACT

A heat exchanger that includes a collecting tank having a collecting tank edge, a tube plate including a tube plate edge, and a seal arrangement with a seal between the collecting tank and tube plate. The heat exchanger further includes a seal support frame, and the seal is arranged on the seal support frame and the seal is inlaid together with the seal support frame between the tube plate edge and the collecting tank edge.

### RELATED APPLICATIONS

This application claims priority to German Patent Application No. 10 2009 049 483.9 filed Oct. 15, 2009, the entire contents of which are hereby incorporated by reference herein.

### BACKGROUND

The invention relates to a heat exchanger having a collecting tank. The invention also relates to a seal arrangement for heat exchangers of said type.

A heat exchanger is known from FR 2 614 980 A. In said document, to reinforce the collecting tank with respect to high internal pressures, receiving openings for a collecting tank insert piece to be inserted are formed on the inner sides of the opposite longitudinal walls of the collecting tank, which collecting tank insert piece can stabilize the longitudinal walls with respect to internal pressure. Said collecting tank insert piece therefore has the function of a collecting tank reinforcement piece.

In the German utility model DE 201 21 112 U1, for the same purpose, stiffening ribs are formed on the longitudinal walls. An inner stiffening element was also provided.

WO 06/005449A1 and WO06/077044A1 likewise provide stiffening ribs on the collecting tank walls.

DE 203 07 881 U1 proposes a solution in which a collecting tank insert piece as a flow-guiding element was also formed with a fastening edge. The fastening edge was inserted, with the addition of a seal, between the collecting tank edge and the tube plate edge, thereby locking the flow-guiding element. The addition of the seal, and the common insertion with the fastening edge during the course of the manufacturing process of the heat exchanger, appear to be cumbersome.

The prior art described here is in need of improvement with regard to the cost-effective manufacture of the heat exchanger, and this is considered to one of the problems addressed by the present invention.

### SUMMARY

In some aspects a solution according to the invention is provided by the use of a seal arrangement having a seal which is arranged between a tube plate edge and a collecting tank edge, which is to be connected thereto, of a heat exchanger, with the seal being fastened to a seal support frame and with it being possible for said seal to be inlaid together with the seal support frame between the tube plate edge and the collecting tank edge. The elastic and in many cases inherently very labile seal is therefore easier to handle and can be inlaid more easily.

Another aspect is that of a collecting tank insert piece and the seal support frame being combined to form a single component. The seal is, as mentioned, arranged or fastened on the seal support frame. The collecting tank insert piece or the common component can therefore, for example, be fastened to the inner sides of the walls of the collecting tank, after which the collecting tank with the insert piece can finally be placed onto the tube plate, before the fastening between the collecting tank edge and the tube plate edge is then carried out with the inclusion of the seal situated on the seal support frame. The invention opens up a number of possibilities for improved automated manufacture of such heat exchangers, because the seal, which is conventionally not particularly easy to handle, is even more dimensionally stable and also remains in its intended position on account of the fastening thereof to the seal support frame and the combination of the latter with the collecting tank insert piece.

A further advantage of the design according to the proposal can be considered to be that of the invention making it possible to use tube plates which do not have an encircling seal-receiving groove, because said tube plates firstly are slightly cheaper to produce and secondly also enable the flat tubes seated in the tube plates to be formed with a slightly greater depth, such that a smaller lateral projecting length of the tube plates beyond the flat tubes is provided, which is conventionally regarded as an unnecessary spatial requirement.

### BRIEF DESCRIPTIONS OF THE DRAWINGS

FIG. 1 shows an exploded perspective view of a part of the heat exchanger according to the invention.

FIG. 2 shows a cut-away illustration of said part in the assembled state.

FIG. 3 shows a seal support frame with seal.

FIG. 4 shows a fastening of the seal to the seal support frame.

FIGS. 5, 6 and 7 show partially different seal support frames with seals.

### DETAILED DESCRIPTION

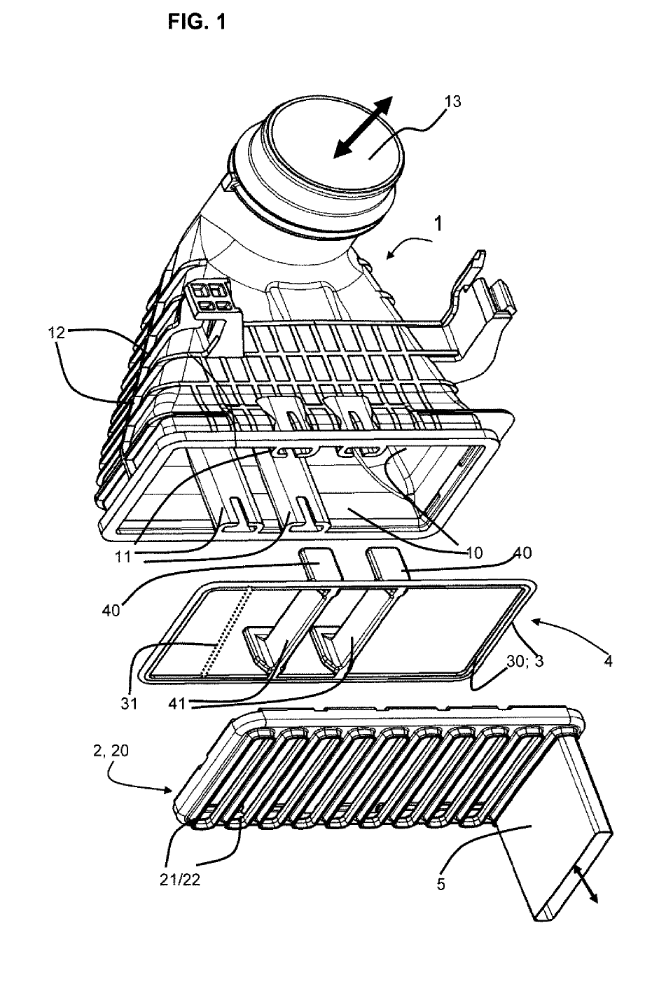

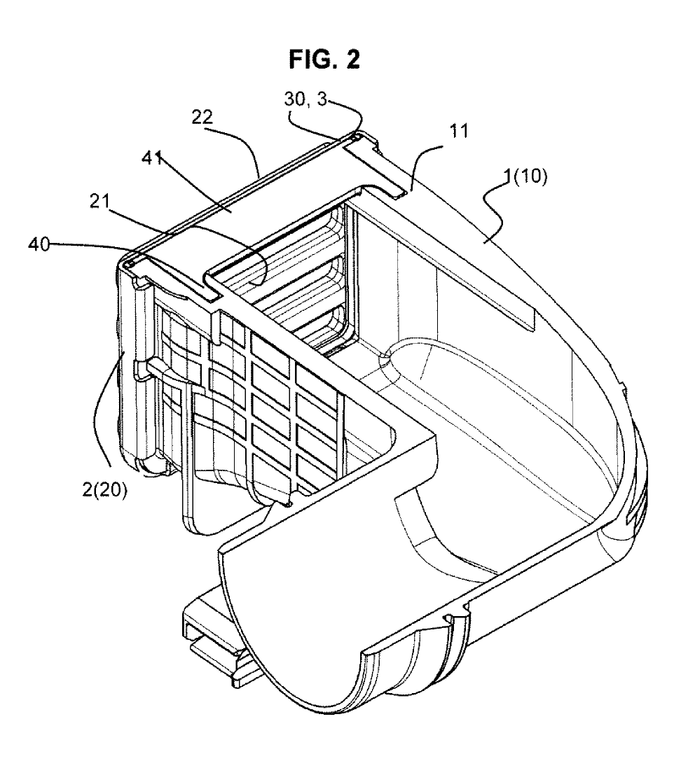

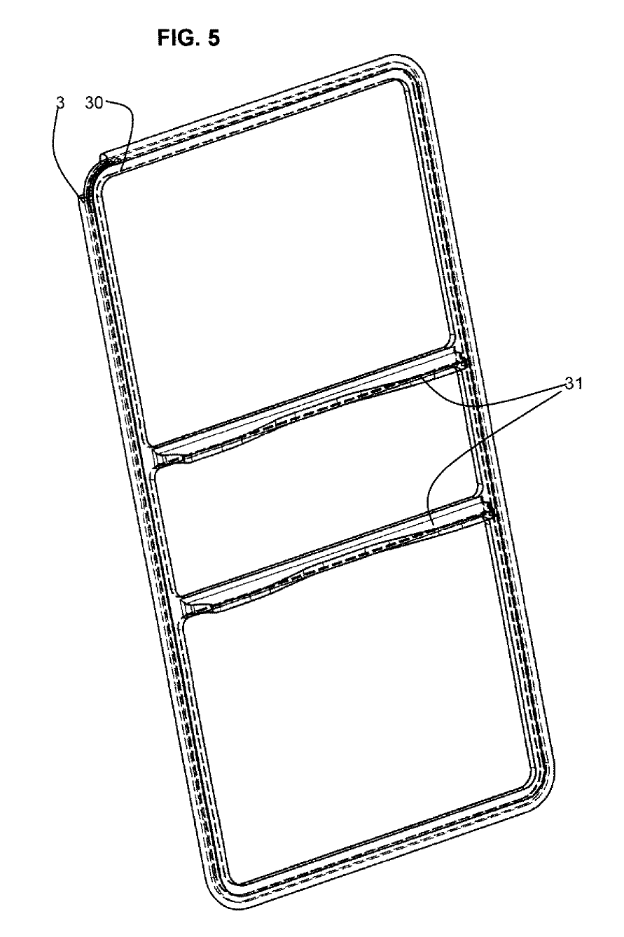

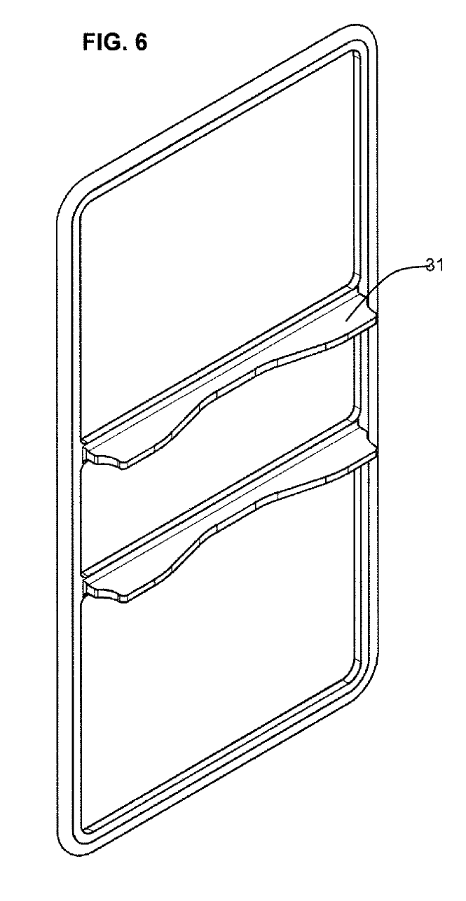

The illustrated heat exchanger part is a part of a charge-air cooler, but this is not intended to restrict the present invention to a charge-air cooler. In contrast, the invention can be applied regardless of the field of use of the heat exchanger. The illustrated heat exchanger part comprises a collecting tank 1, a collecting tank insert piece 4 and a tube plate 2. The collecting tank 1 has, in the conventional way, an opening 13 through which, in the present case, the charge air flows in and out. The walls 10 of the collecting tank 1 have ribs 12 which run in the longitudinal and transverse direction, in order to increase the stability of said walls 10. Arranged in the tube plate 2 are receiving openings 21 for receiving the ends of flat tubes 5, of which only a single one has been shown in FIG. 1. The charge air flows through the flat tubes 5, for example in order to be cooled by means of cooling air. The receiving openings 21 have been provided with collars 22 which, in the exemplary embodiment, point outwards. The flat tube ends are sealingly soldered or fastened in some other way to the collars 22. An identical design may be provided at the opposite end (not shown) of the flat tubes 5. The collecting tank edge and the tube plate edge are connected to one another in a mechanically fixed and sealed manner with the interposition of a seal 3. FIG. 2 shows a piece of said connection. In the exemplary embodiment (FIGS. 1, 2) the collecting tank insert piece 4 acts so as to reinforce the collecting tank with respect to high internal pressures. In other embodiments (FIGS. 5, 6), the insert piece 4 functions primarily as a flow-guiding piece and has be specifically adapted for this purpose.

As is now shown particularly clearly in FIG. 1, the collecting tank insert piece 4 and a seal support frame 30 have been combined to form a single or common component. The elastic seal 3 has been fastened to the seal support frame 30. The collecting tank insert piece 4 or the component is detachably fastened to the inner sides of the walls 10 of the collecting piece 1. For this purpose, receptacles 11 are formed oppositely on the inner sides of the longitudinal walls 10 of the collecting tank 1, into which receptacles 11 corresponding end pieces 40 of the collecting tank insert piece 4 can be received in a positively locking fashion. In physical terms, the collecting tank insert piece 4 can be pushed with its fitting end pieces 40 into the receptacles 11 in the longitudinal direction or in the direction of the said flat tubes 5, until the end pieces 40 come to bear there against a stop (not shown), or can latch in. The end pieces 40 are situated at opposite ends of at least one web 41 which operatively provides the desired reinforcement. In the exemplary embodiment, there are two webs 41 and four end pieces 40. It is self-evident that said webs 41 also have a streamlined, that is to say extremely slim form, even if this is not clearly visible from the figures.

The common component has the said seal support frame 30. In the exemplary embodiment shown, the seal support frame 30 has an approximately rectangular shape. The shape must correspond approximately to the edge of the collecting tank 1 and to that of the tube plate 2. The seal 3 may for example be injection-molded or vulcanized onto said seal support frame 30.

As FIG. 1 is likewise intended to show, the webs 41, the end pieces 40 thereof and the seal support frame 30 form a single piece, which is produced for example from plastic by injection molding. Depending on the size of the seal support frame 30 or of the tube plate/collecting tank, the seal support frame 30 may have additional supports 31, which has been indicated in FIG. 1 by means of dashed lines. The heat exchanger of the exemplary embodiment shown does not have such supports 31. Depending on size, the collecting tank insert piece 4 may self-evidently also have more than two webs 41 with end pieces 40, including corresponding receptacles 11 on the wall of the collecting tank. The webs 41 are arranged between the receiving openings 21. This also normally applies to the said supports 31, if these are provided.

When the collecting tank 1 and the tube plate 2 are joined together, the seal support frame 30 presses the seal 3 firmly against the encircling, upturned edge 20 of the tube plate 2, without said seal being braced between the collecting tank and tube plate. The clamping is carried out, with the seal 3 coming to rest between the collecting tank edge and tube plate edge.

It is advantageous for the tube plate 2 to be formed to be approximately planar aside from the collars 22 and the upturned edge; at any rate, said tube plate need not have an encircling seal-receiving groove, as a result of which it can be manufactured using simpler tools.

The seal support frame 30 is positioned approximately between the edge of the collecting tank and the edge of the tube plate. Said seal support frame has a supporting action during the clamping of the tube plate edge to the collecting tank edge.

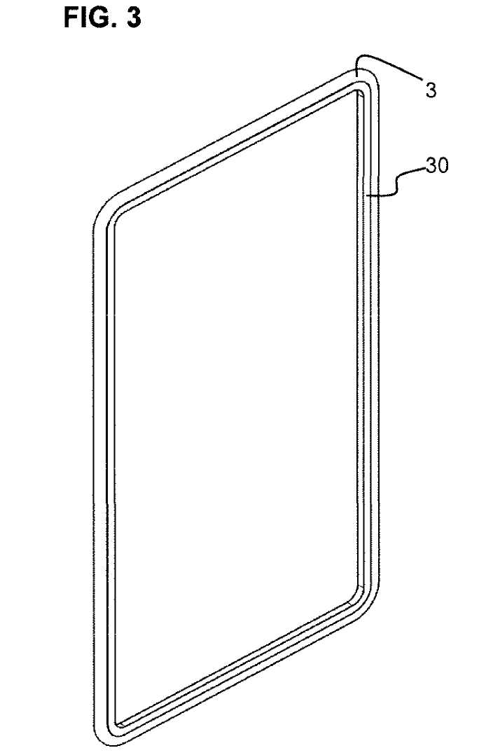

A collecting tank reinforcement piece 4 has been dispensed with in the exemplary embodiments according to FIGS. 3-7.

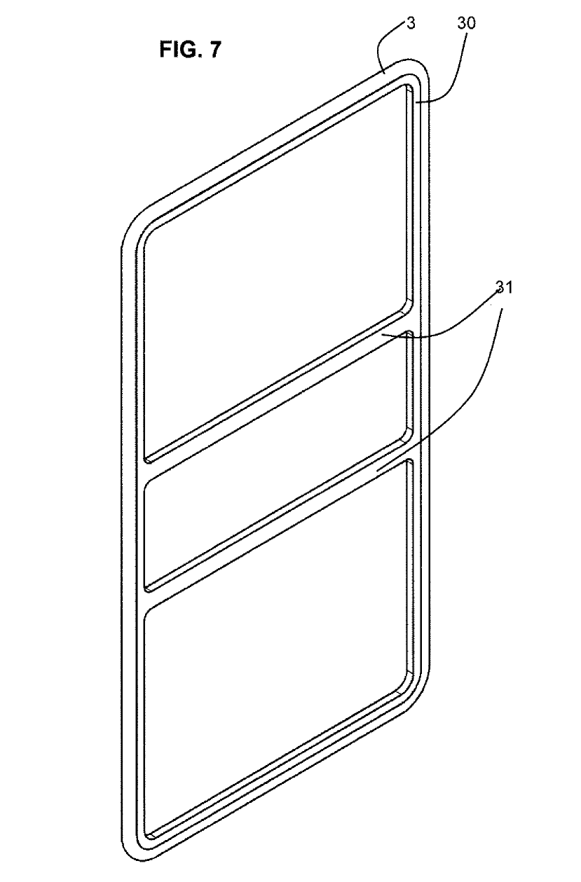

The embodiment shown in FIG. 3 is advantageous for extremely small heat exchangers, in which the stiffness of the seal support frame 30 alone is adequate. To increase stiffness, struts 31 may be provided in one piece with the seal support frame 30, which struts 31 may also have flow-deflecting properties, as shown in FIGS. 5 and 6. These properties are not provided in FIG. 7; in said figure, the aim of the struts 31 is only to provide stiffening. The main task of the struts 31 is to support the inwardly directed forces that occur during the so-called clamping of the tube plate edge to the collecting tank edge.

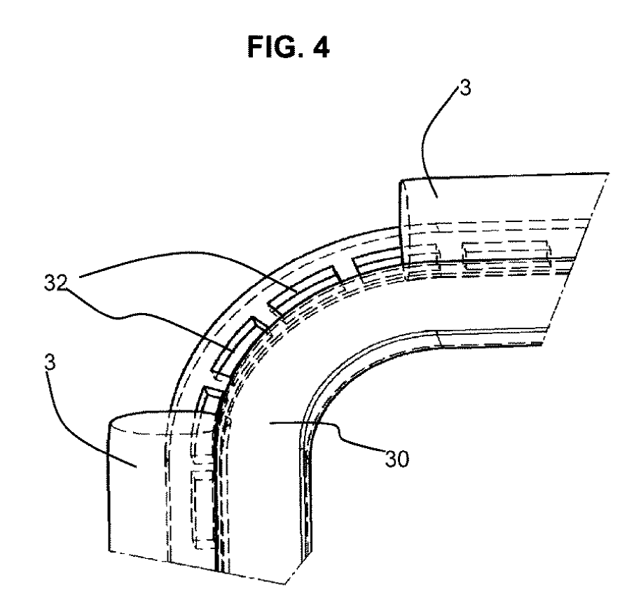

FIG. 4 shows, on the basis of a corner detail of the seal support frame 30 with seal 3, an example of how the fastening of the seal 3 may take place. The seal support frame 30 is provided with a series of apertures 32 into which projections of the seal 3 engage. The seal support frame 30 has an encircling concave curvature in which the approximately round seal 3 can be partially seated.

The seal 3 is for example injection molded onto, vulcanized onto, adhesively bonded onto and/or, as shown in FIG. 4, for example fastened in a positively locking manner to the seal support frame 30.

What is claimed is:

1-10. (canceled)

11. A heat exchanger comprising:
a collecting tank having a collecting tank edge;
a tube plate including a tube plate edge;
a seal arrangement with a seal between the collecting tank and tube plate; and
a seal support frame,
wherein the seal is arranged on the seal support frame and the seal is inlaid together with the seal support frame between the tube plate edge and the collecting tank edge.

12. The heat exchanger according to claim 11, further comprising a collecting tank insert piece that is fastened in the collecting tank, wherein the collecting tank insert piece and the seal support frame are combined to form a common component.

13. The heat exchanger according to claim 12, wherein at least one of the collecting tank insert piece and the common component is detachably fastened to inner side of walls of the collecting tank.

14. The heat exchanger according to claim 12, further comprising receptacles formed oppositely on inner sides of longitudinal walls of the collecting tank,
wherein corresponding end pieces of at least one of the collecting tank insert piece and the common component are received in a positively locking manner in the receptacles.

15. The heat exchanger according to claim 11, wherein the seal is injection-molded onto the seal support frame.

16. The heat exchanger according to claim 11, wherein the seal is vulcanized onto the seal support frame.

17. The heat exchanger according to claim 11, wherein the seal is adhesively bonded onto the seal support frame.

18. The heat exchanger according to claim 11, wherein the seal is fastened in a positively locking manner to the seal support frame.

19. The heat exchanger according to claim 11, wherein the tube plate is of approximately planar design and does not have an encircling seal-receiving groove.

20. The heat exchanger according to claim 13, wherein at least one of the collecting tank insert piece and the common component has at least one web that connects and stabilize the walls of the collecting tank.

21. The heat exchanger according to claim 12, wherein the collecting tank insert piece is at least one of a reinforcement piece and a flow-guiding piece.

22. The heat exchanger according to claim 11, wherein the seal support frame is formed without supports.

23. The heat exchanger according to claim 11, wherein the seal support frame includes at least one of transverse and longitudinal struts for support.

24. A seal arrangement for use with a heat exchanger that includes a collection tank and a tube plate connected to the collection tank, the seal arrangement comprising:
a seal configured to be placed between the tube plate and the collecting tank; and
a seal support frame,
wherein the seal is arranged on the seal support frame and inlaid together with the seal support frame configured to be placed between an edge of the tube plate and an edge of the collecting tank.

25. The seal arrangement of claim 24, further comprising a collecting tank insert piece configured to be fastened in the collecting tank, wherein the collecting tank insert piece and the seal support frame are combined to form a common component.

26. The seal arrangement of claim 25, wherein the common component includes end pieces that are configured to be received in a positively locking manner in receptacles formed oppositely on inner sides of longitudinal walls of the collecting tank.

27. The seal arrangement of claim 24, wherein the seal is injection-molded onto the seal support frame.

28. The seal arrangement of claim 24, wherein the seal is vulcanized onto the seal support frame.

29. The seal arrangement of claim 25, wherein the common component has at least one web configured to connect and stabilize walls of the collecting tank.

30. The seal arrangement of claim 24, wherein the seal support frame includes at least one of transverse and longitudinal struts for support.
